(19) United States
(12) Patent Application Publication
(10) Pub. No.: US 2023/0005467 A1
(43) Pub. Date: Jan. 5, 2023

(54) DIALOGUE APPARATUS, METHOD AND PROGRAM

(71) Applicant: NIPPON TELEGRAPH AND TELEPHONE CORPORATION, Tokyo (JP)

(72) Inventors: Kazunori YAMADA, Tokyo (JP); Takashi NAKAMURA, Tokyo (JP)

(73) Assignee: NIPPON TELEGRAPH AND TELEPHONE CORPORATION, Tokyo (JP)

(21) Appl. No.: 17/779,528

(22) PCT Filed: Nov. 26, 2019
(86) PCT No.: PCT/JP2019/046184

§ 371 Date: May 24, 2022

(51) Int. Cl. G10L 13/08; G10L 13/10; G10L 15/08; G10L 15/22

(52) U.S. Cl. CPC G10L 13/086; G10L 13/10; G10L 15/08; G10L 15/22

(57) ABSTRACT

A dialogue apparatus includes a speech recognition unit (1) configured to perform speech recognition on utterance input to generate a text corresponding to the utterance, a speech waveform corresponding to the utterance, and information regarding a length of sound of the utterance; a language understanding unit (2) configured to grasp contents of the utterance by using the text corresponding to the utterance; a dialogue management unit (3) configured to determine contents of a response corresponding to the utterance by using the content of the utterance; an utterance state extraction unit (4) configured to extract a state of the utterance by using the text corresponding to the utterance, the speech waveform corresponding to the utterance, and the information regarding the length of the sound of the utterance; a response state determination unit (5) configured to determine a state of the response according to the state of the utterance; a response sentence generation unit (6) configured to generate a response sentence by using the content of the response; and a speech synthesis unit (7) configured to synthesize speech corresponding to the response sentence with the state of the response taken into account.

### TECHNICAL FIELD

The present invention relates to a technology of generating more natural response utterance in speech dialogue by using synthetic speech.

### BACKGROUND ART

General speech synthesis in the related art has been performed in accordance with text information input to a speech synthesis unit (see PTL 1, for example).

In general speech dialogue systems in the related art, utterance responses are made by performing speech recognition for utterance of a dialog partner, converting the utterance into a text for language understanding, and generating a response sentence to perform speech synthesis while managing the state of the dialogue (see PTL 2, for example).

### CITATION LIST

### Patent Literature

PTL 1: JP 01-284898 A

PTL 2: JP 2018-133070 A

### SUMMARY OF THE INVENTION

### Technical Problem

However, how utterance is made by a system in a dialogue system depends on a text input to a speech synthesis unit. Whether a person who is a dialogue partner can naturally have a dialogue with a system depends on a text to be generated and output by a response generation unit.

As described above, because the speech to be uttered for response depends only on text information generated in the response generation unit, a gap may occur between the state of uttered speech itself by the actual dialogue partner and the state of the speech of the response utterance even when response is appropriately performed on the text.

An object of the present invention is to provide a dialogue apparatus, a method, and a program for achieving more natural dialogue.

### Means for Solving the Problem

A dialogue apparatus according to one aspect of the invention includes a speech recognition unit configured to perform speech recognition on utterance input and generate a text corresponding to the utterance, a speech waveform corresponding to the utterance, and information regarding a length of sound of the utterance; a language understanding unit configured to grasp a content of the utterance by using the text corresponding to the utterance; a dialogue management unit configured to determine a content of a response corresponding to the utterance by using the content of the utterance; an utterance state extraction unit configured to extract a state of the utterance by using the text corresponding to the utterance, the speech waveform corresponding to the utterance, and the information regarding the length of the sound of the utterance; a response state determination unit configured to determine a state of the response according to the state of the utterance; a response sentence generation unit configured to generate a response sentence by using the content of the response; and a speech synthesis unit configured to synthesize speech corresponding to the response sentence with the state of the response taken into account.

### Effects of the Invention

More natural dialogue can be achieved.

### BRIEF DESCRIPTION OF DRAWINGS

FIG. 1 is a diagram illustrating an example of a functional configuration of a dialogue apparatus.

FIG. 2 is a diagram illustrating an example of a processing procedure of a dialogue method.

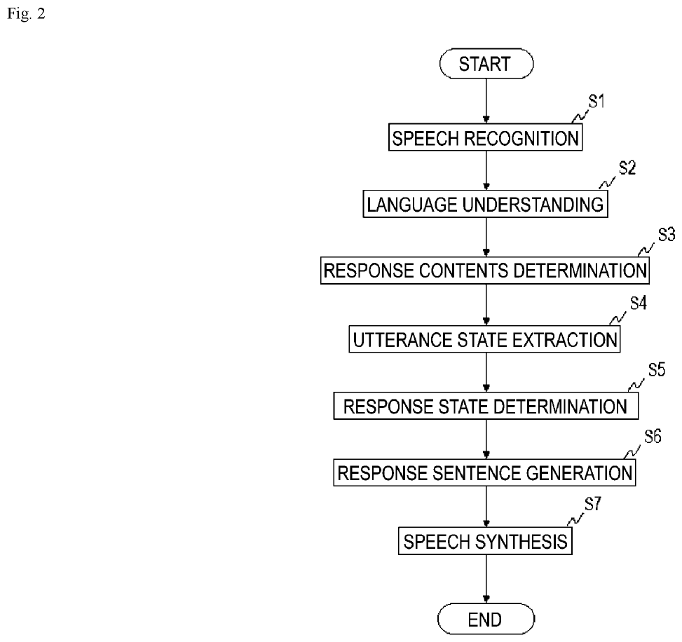

FIG. 3 is a diagram for explaining an example of processing of a response state determination unit 5.

FIG. 4 is a diagram for explaining another example of processing of the response state determination unit 5.

FIG. 5 is a diagram illustrating a functional configuration example of a computer.

### DESCRIPTION OF EMBODIMENTS

Hereinafter, embodiments of the present invention will be described in detail. The same reference numerals are given to components having the same functions in the drawings, and repeated description will be omitted.

### First Embodiment

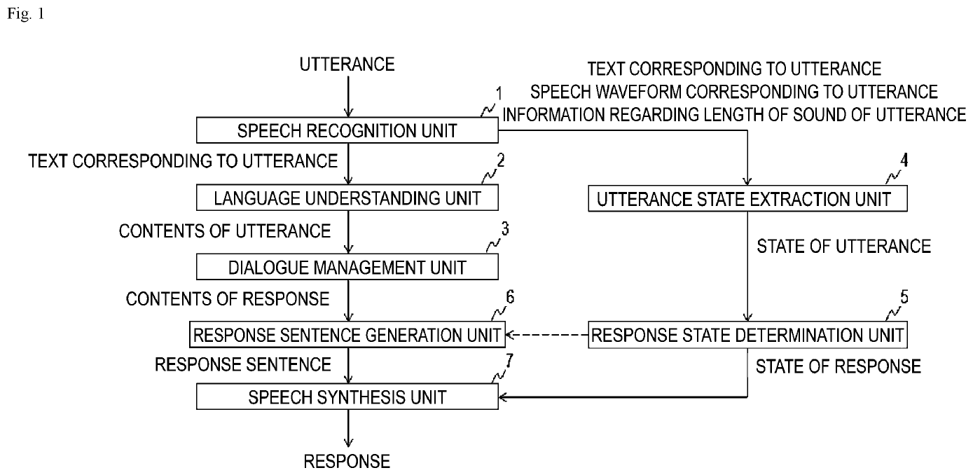

As illustrated in FIG. 1, as an example, a dialogue apparatus includes a speech recognition unit 1, a language understanding unit 2, a dialogue management unit 3, an utterance state extraction unit 4, a response state determination unit 5, a response sentence generation unit 6, and a speech synthesis unit 7.

The dialogue method is achieved, for example, by performing processing of steps S1 to S7 described below and illustrated in FIG. 1 by components of the dialogue apparatus.

The components of the dialogue apparatus will be described below.

Speech Recognition Unit 1

Utterance is input to the speech recognition unit 1.

The speech recognition unit 1 performs speech recognition on utterance input and generates a text corresponding to the utterance, a speech waveform corresponding to the utterance, and information regarding a length of sound of the utterance (step S1).

The text corresponding to the utterance is sometimes also referred to as “uttered sentence”.

The generated text corresponding to the utterance is output to the language understanding unit 2 and the utterance state extraction unit 4.

The speech waveform corresponding to the utterance and the information regarding the length of the sound of the utterance are output to the utterance state extraction unit 4.

The information regarding the length of the sound of the utterance may be a length of the utterance itself, or a length of each of phonemes constituting the utterance.

An example of utterance input to the speech recognition unit 1 is “What is the weather tomorrow?”

Language Understanding Unit 2

The text corresponding to utterance generated in the speech recognition unit 1 is input to the language understanding unit 2.

The language understanding unit 2 uses the text corresponding to the utterance to grasp contents of the utterance (step S2). The grasped contents are output to the dialogue management unit 3.

The content of the utterance is, for example, information regarding so-called dialogue action. The dialogue action includes at least information regarding an action type and an attribute (see, for example, Reference Literature 1).
[Reference Literature 1] Hironsan, “Dialogue system made using machine learning”, [online], [Searched on Nov. 13, 2019], Internet [URL: https://qiita.com/Hironsan/items/6425787ccbee75dfae36] Examples of dialogue types of utterance include a question, a greeting, and an assertion.

An example of contents of utterance when utterance input to the speech recognition unit 1 is “What is the weather tomorrow?” is (action type=question, time attribute=tomorrow).

Dialogue Management Unit 3

The contents of the utterance grasped in the language understanding unit 2 are input to the dialogue management unit 3.

The dialogue management unit 3 uses the contents of the utterance to determine contents of a response corresponding to the utterance (step S3).

The determined contents of the response are output to the response sentence generation unit 6.

The contents of the response are, for example, information regarding a dialogue type. Examples of the dialogue type of response are an answer, an answer (a lie), a question, a greeting, an apology, and a confirmation.

The dialogue management unit 3 determines the contents of the response according to the method described in Reference Literature 1, for example. That is, the dialogue management unit 3 updates the internal state on the basis of the contents of the utterance input and determines the dialogue type that is the contents of the utterance on the basis of the updated internal state. At that time, the dialogue management unit 3 may use an external API to determine the contents of the utterance.

An example of the contents of the response when the contents of the utterance are (action type=question, time attribute=tomorrow) is (action type=answer, weather attribute=sunny).

Utterance State Extraction Unit 4

The text corresponding to the utterance generated in the speech recognition unit 1, the speech waveform corresponding to the utterance, and the information regarding the length of the sound of the utterance are input to the utterance state extraction unit 4.

The utterance state extraction unit 4 extracts the state of the utterance by using the text corresponding to the utterance, the speech waveform corresponding to the utterance, and the information regarding the length of the sound of the utterance (step S4).

The extracted state of the utterance is output to the response state determination unit 5.

The state of the utterance is information related to a state of utterance, such as at least an utterance speed or an emotion of a person who made the utterance. The state of utterance may include the utterance tone by the person who made the utterance.

The utterance speed is information regarding a speed of utterance. The utterance speed is, for example, the number of characters or phonemes included per unit time.

Examples of the emotion of the person who made the utterance include normal, pleasure, sadness, anger, calm, excitement, composure, depression, anxiety, humbleness, cheerful, and gloomy. For example, the utterance state extraction unit 4 determines the emotion of the person who made the utterance by categorizing the emotion to any of normal, pleasure, sadness, anger, calm, excitement, composure, depression, anxiety, humbleness, cheerful, gloomy, and the like. The utterance state extraction unit 4 may determine the emotion of the person who made the utterance by categorizing the emotion to any of normal, pleasure, sadness, and anger. The utterance state extraction unit 4 may determine the emotion of the person who made the utterance by categorizing the emotion to any of calm, excitement, composure, depression, anxiety, and humbleness. The utterance state extraction unit 4 may determine the emotion of the person who made the utterance by categorizing the emotion to any of cheerful or gloomy.

The utterance state extraction unit 4 can determine the emotion of the person who made the utterance by, for example, the method described in Reference Literature 2. The emotion of the person who made the utterance is determined, for example, on the basis of the text corresponding to the utterance and the speech waveform corresponding to the utterance.
[Reference Literature 2] Saori Amanuma, Riki Kurematsu, Jun Hakura, and Hamid Fujita, “An idea of Criterion for Cluster Analysis Criteria to Estimate Emotion in Speech”, Information Processing Society of Japan, 73rd National Convention, 2011 The utterance tone of the person who made the utterance is, for example, formal or casual. Casual here refers to not formal.

The utterance state extraction unit 4 can determine the utterance tone of the person who made the utterance by, for example, the method described in Reference Literature 3. The utterance tone of the person who made the utterance is determined, for example, on the basis of the text corresponding to the utterance and the speech waveform corresponding to the utterance.
[Reference Literature 3] Akira Baba, Takehiro Sekine, Shinpei Hibiya, Fumiaki Obayashi, Akira Terasawa, Takashi Nishiyama, Ryoji Nakashima, “Application of Tone Identification to Humanoid Agents”, Information Processing Society of Japan, 66th National Convention, 2004

Response State Determination Unit 5

The state of the utterance extracted in the utterance state extraction unit 4 is input to the response state determination unit 5.

The response state determination unit 5 determines the state of the response in accordance with the state of the utterance (step S5).

The determined state of the response is output to the speech synthesis unit 7.

### Example 1 of Processing of Response State Determination Unit 5

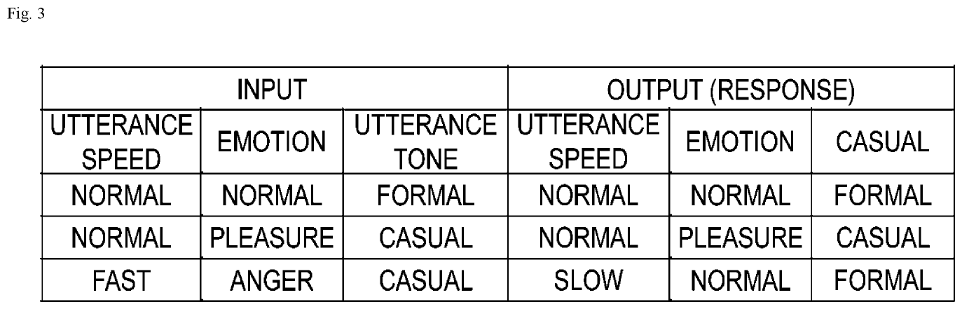

The response state determination unit 5 can determine the state of the response on the basis of a predetermined rule, for example, in response to a state of the utterance input. Examples of the predetermined rule are shown in the conversion table illustrated in FIG. 3.

With the conversion table illustrated in FIG. 3, when the state of the utterance input is, for example, (utterance speed=normal, emotion of person who made utterance=normal, utterance tone of person who made utterance=formal), the state of the response (utterance speed=normal, emotion of response=normal, utterance tone of response=formal) is determined.

With the conversion table illustrated in FIG. 3, when the state of the utterance input is, for example, (utterance speed=normal, emotion of person who made utterance=pleasure, utterance tone of person who made utterance=casual), the state of the response (utterance speed=normal, emotion of response=pleasure, utterance tone of response=casual) is determined. As described above, when the utterance tone of the person who made the utterance is casual, the utterance tone of the response is made casual so that a frank response to a frank question in consultation can be achieved.

With the conversion table illustrated in FIG. 3, when the state of the utterance input is, for example, (utterance speed=fast, emotion of person who made utterance=anger, utterance tone of person who made utterance=casual), the state of the response (utterance speed=slow, emotion of response=normal, utterance tone of response=formal) is determined. As described above, when the emotion of the person who made the utterance is anger, the utterance speed of the response is made slow, the emotion of the response is made normal, and the utterance tone of the response is made formal, so that it is possible to calm down the person who made the utterance.

In the conversion table of FIG. 3, only the state of the response corresponding to each of the three states of utterance is shown. For example, it is assumed that, in a conversion table that the response state determination unit 5 actually uses, states of response corresponding to all states of utterance are determined.

The response state determination unit 5 may determine states of the response by using the conversion table for particular states of utterance described in the conversion table and may determine a predetermined state of the response as the state of the response output by the response state determination unit 5 for other states of utterance.

### Example 2 of Processing of Response State Determination Unit 5

The response state determination unit 5 may determine the state of the response by using a nonlinear transformation that uses a neural network or the like.

For example, the number of dimensions of the input layer of the neural network is the sum of the number of types of utterance speed of an utterance, the number of types of emotions of an utterance, and the number of types of utterance tone of an utterance, and the number of dimensions of the output layer of the neural network is the sum of the number of types of utterance speed of a response, the number of types of emotions of a response, and the number of types of the utterance tone of a response. The number of intermediate layers (hidden layers) of the neural network is optional. The number of dimensions of each intermediate layer (hidden layer) is also optional.

For certain utterance input, 1 is input for the relevant type of utterance speed, emotion, and utterance tone, and 0 is input for non-relevant types. For example, for the utterance in which the utterance speed is normal, the emotion is normal, and the utterance tone is formal, 1 is input for an input node in which the utterance speed is normal (as is the case for emotion and utterance tone), and 0 is input for an input node in which the utterance speed is fast or the like.

Parameters of the neural network are adjusted such that the output values output from the neural network due to the input approach the output of the corresponding response, and thereby, a learned model of the pattern of the conversion of the state of the utterance as an input and the state of the response is generated. In the above example, parameters are adjusted such that the output node in which the utterance speed of the response is normal, the emotion of the response is normal, and the utterance tone of the response is formal outputs 1, and the other output nodes output 0.

Utilizing a neural network may allow for a corresponding response to be made in a form similar to an existing pattern even in a case of utterance of an input pattern that is not in current patterns.

Although the above-described manner of utilizing is limited to input of 0 and 1, when the utilization is extended to allow for a continuous value, it may be possible to respond with subtle nuances for subtle utterance in which utterance speed, emotion, and the like are moderate.

Response Sentence Generation Unit 6

The contents of the response determined in the dialogue management unit 3 are input to the response sentence generation unit 6.

The response sentence generation unit 6 generates a response sentence by using the contents of the response (step S6).

The generated response sentence is output to the speech synthesis unit 7.

When an example of the contents of the response is (action type=answer, weather attribute=sunny), an example of the response sentence is “sunny”.

Speech Synthesis Unit 7

The response sentence generated in the response sentence generation unit 6 and the state of the response determined in the response state determination unit 5 are input to the speech synthesis unit 7.

The speech synthesis unit 7 synthesizes the speech corresponding to the response sentence with the state of the response taken into account (step S7).

The synthesized speech is output from the dialogue apparatus.

As described above, not only text but also information on the state of the utterance of the partner of the dialogue obtained from the utterance speech of the partner is also input, and speech synthesis is performed also in consideration of the state. This enables more natural dialogue to be achieved.

First Modification

The state of the response determined by the response state determination unit 5 may include an utterance tone of the response.

In this case, the response sentence generation unit 6 may generate the response sentence in consideration of the utterance tone of the response included in the state of the response determined by the response state determination unit 5.

By generating a response sentence in consideration of the utterance tone of the person who made the utterance, further natural dialogue can be achieved.

For example, when an example of the contents of the response is (action type=answer, weather attribute=sunny) and the utterance tone of the response=formal, the response sentence generation unit 6 generates a response sentence of “The weather is sunny”. When an example of the contents of the response is (action type=answer, weather attribute=sunny) and the utterance tone of the response=casual, the response sentence generation unit 6 generates a response sentence of “It's sunny”.

### Second Modified Example

The response state determination unit 5 may determine the state of the response further according to at least one of the text corresponding to the utterance, the contents of the utterance, the contents of the response, or information obtained up to when the dialogue management unit 3 determines the contents of the response.

The information obtained up to when the dialogue management unit 3 determines the contents of the response is internal information in the dialogue management unit 3, for example.

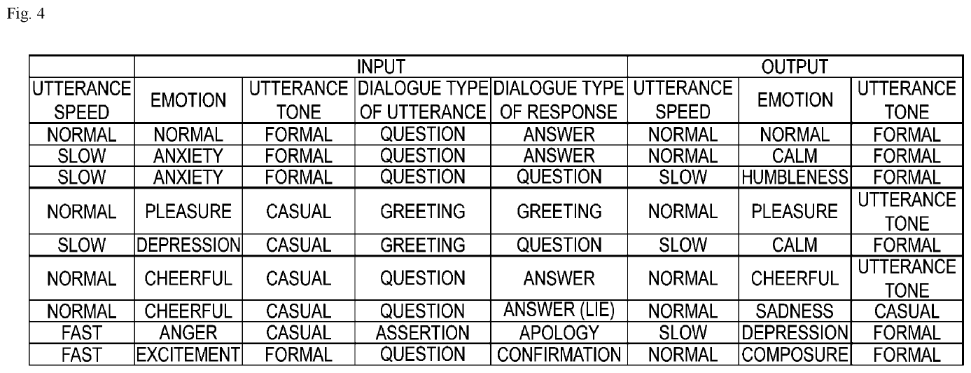

FIG. 4 illustrates an example of a conversion table that is a predetermined rule used when the response state determination unit 5 determines the state of the response further on the basis of the dialogue type of utterance that is the contents of the utterance and the dialogue type of response that is the contents of the response.

With the conversion table illustrated in FIG. 4, when the input for the utterance is, for example, (utterance speed=normal, emotion of person who made utterance=normal, utterance tone of person who made utterance=formal, dialogue type of utterance=question, dialogue type of response=answer), the state of the response (utterance speed=normal, emotion of response=normal, utterance tone of response=formal) is determined. As a result, it is possible to correspond to a normal inquiry.

With the conversion table illustrated in FIG. 4, when the input for the utterance is, for example, (utterance speed=slow, emotion of person who made utterance=anxiety, utterance tone of person who made utterance=formal, dialogue type of utterance=question, dialogue type of response=answer), the state of the response (utterance speed=normal, emotion of response=calm, utterance tone of response=formal) is determined. As a result, it is possible to correspond to an inquiry with an anxiety and hesitating emotion.

With the conversion table illustrated in FIG. 4, when the input for the utterance is, for example, (utterance speed=slow, emotion of person who made utterance=anxiety, utterance tone of person who made utterance=formal, dialogue type of utterance=question, dialogue type of response=question), the state of the response (utterance speed=slow, emotion of response=humbleness, utterance tone of response=formal) is determined. As a result, it is possible to ask a question while corresponding to an inquiry with an anxiety and hesitating emotion.

With the conversion table illustrated in FIG. 4, when the input for the utterance is, for example, (utterance speed=normal, emotion of person who made utterance=pleasure, utterance tone of person who made utterance=casual, dialogue type of utterance=greeting, dialogue type of response=greeting), the state of the response (utterance speed=normal, emotion of response=pleasure, utterance tone of response=casual) is determined. As a result, it is possible to achieve exchange of greetings.

With the conversion table illustrated in FIG. 4, when the input for the utterance is, for example, (utterance speed=slow, emotion of person who made utterance=depression, utterance tone of person who made utterance=casual, dialogue type of utterance=greeting, dialogue type of response=question), the state of the response (utterance speed=slow, emotion of response=calm, utterance tone of response=formal) is determined. As a result, it is possible to achieve a formal response (for example, “Are you all right?”) corresponding to utterance with depressed emotion.

With the conversion table illustrated in FIG. 4, when the input for the utterance is, for example, (utterance speed=normal, emotion of person who made utterance=cheerful, utterance tone of person who made utterance=casual, dialogue type of utterance=question, dialogue type of response=answer), the state of the response (utterance speed=normal, emotion of response=cheerful, utterance tone of response=casual) is determined. As a result, it is possible to provide a normal answer to a frank question in consultation.

With the conversion table illustrated in FIG. 4, when the input for the utterance is, for example, (utterance speed=normal, emotion of person who made utterance=cheerful, utterance tone of person who made utterance=casual, dialogue type of utterance=question, dialogue type of response=answer (lie)), the state of the response (utterance speed=normal, emotion of response=sadness, utterance tone of response=casual) is determined. As a result, it is possible to provide an answer that is not really consistent with the question with respect to a frank question in consultation.

With the conversion table illustrated in FIG. 4, when the input for the utterance is, for example, (utterance speed=fast, emotion of person who made utterance=anger, utterance tone of person who made utterance=casual, dialogue type of utterance=assertion, dialogue type of response=apology), the state of the response (utterance speed=slow, emotion of response=depression, utterance tone of response=formal) is determined. As a result, it is possible to achieve correspondence of complaints in a call center and the like.

With the conversion table illustrated in FIG. 4, when the input for the utterance is, for example, (utterance speed=fast, emotion of person who made utterance=excitement, utterance tone of person who made utterance=formal, dialogue type of utterance=question, dialogue type of response=confirmation), the state of the response (utterance speed=normal, emotion of response=composure, utterance tone of response=formal) is determined. As a result, it is possible to perform repetition or the like for an emergency inquiry.

### OTHER MODIFICATIONS

Although the embodiments and modifications of the present invention have been described above, a specific configuration is not limited to the embodiments, the present invention, of course, also includes configurations appropriately changed in the design without departing from the gist of the present invention.

The various kinds of processing described in the embodiments are not only implemented in the described order in a time-series manner but may also be implemented in parallel or separately as necessary or in accordance with a processing capability of the device which performs the processing.

For example, the exchange of data between the components of the dialogue apparatus may be performed directly or via a storage unit not illustrated.

Program and Recording Medium

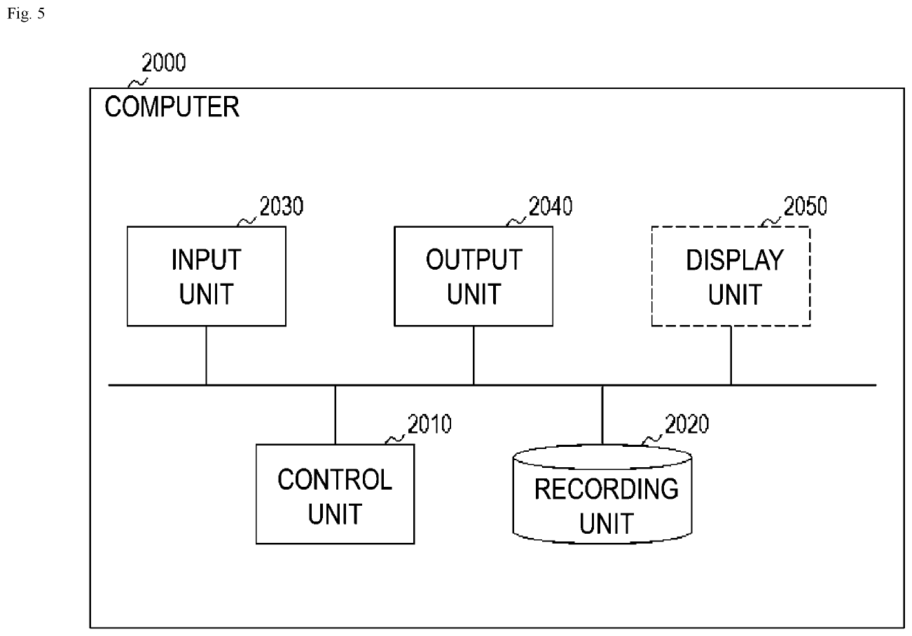

When various processing functions in the devices described above are implemented by a computer, processing details of the functions that each of the devices should have are described by a program. In addition, when the program is executed by the computer, the various processing functions of each device described above are implemented on the computer. For example, a variety of processing described above can be performed by causing a recording unit 2020 of the computer illustrated in FIG. 5 to read a program to be executed and causing a control unit 2010, an input unit 2030, an output unit 2040, and the like to execute the program.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in its own storage device. When executing the processing, the computer reads the program stored in its own storage device and executes the processing in accordance with the read program. Further, as another execution mode of this program, the computer may directly read the program from the portable recording medium and execute processing in accordance with the program, or, further, may sequentially execute the processing in accordance with the received program each time the program is transferred from the server computer to the computer. In addition, another configuration to execute the processing through a so-called application service provider (ASP) service in which processing functions are implemented just by issuing an instruction to execute the program and obtaining results without transmitting the program from the server computer to the computer may be employed. Further, the program in this mode is assumed to include information which is provided for processing of a computer and is equivalent to a program (data or the like that has characteristics of regulating processing of the computer rather than being a direct instruction to the computer).

In addition, although the device is configured by executing a predetermined program on a computer in this mode, at least a part of the processing details may be implemented by hardware.

### REFERENCE SIGNS LIST

1 Speech recognition unit
2 Language understanding unit
3 Dialogue management unit
4 Utterance state extraction unit
5 Response state determination unit
6 Response sentence generation unit
7 Speech synthesis unit

1. A dialogue apparatus comprising a processor configured to execute a method comprising:
performing speech recognition on utterance input to generate a text corresponding to the utterance, a speech waveform corresponding to the utterance, and information regarding a length of sound of the utterance;
understanding a content of the utterance by using the text corresponding to the utterance;
determining a content of a response corresponding to the utterance by using the content of the utterance;
extracting a state of the utterance by using the text corresponding to the utterance, the speech waveform corresponding to the utterance, and the information regarding the length of the sound of the utterance;
determining a state of the response according to the state of the utterance;
generating a response sentence by using the content of the response; and
synthesizing speech corresponding to the response sentence with the state of the response taken into account.

2. The dialogue apparatus according to claim 1, wherein
the state of the utterance includes at least an utterance speed, and an emotion of a person who makes the utterance.

3. The dialogue apparatus according to claim 1, wherein
the state of the response includes an utterance tone of the response, and
the generating generates the response sentence in consideration of the utterance tone of the response included in the state of the response.

4. The dialogue apparatus according to claim 1, wherein
the determining the state of the response determines the state of the response further according to at least one of the text corresponding to the utterance, the content of the utterance, the content of the response, or information obtained until the determining the content of the response determines the content of the response.

5. A dialogue method comprising:
performing speech recognition on utterance input to generate a text corresponding to the utterance, a speech waveform corresponding to the utterance, and information regarding a length of sound of the utterance;
grasping a content of the utterance by using the text corresponding to the utterance;
determining a content of a response corresponding to the utterance by using the content of the utterance;
extracting a state of the utterance by using the text corresponding to the utterance, the speech waveform corresponding to the utterance, and the information regarding the length of the sound of the utterance;
determining a state of the response according to the state of the utterance;
generating a response sentence by using the content of the response; and
synthesizing speech corresponding to the response sentence with the state of the response taken into account.

6. A computer-readable non-transitory recording medium storing computer-executable program instructions that when executed by a processor cause for a computer to execute a method comprising:
performing speech recognition on utterance input to generate a text corresponding to the utterance, a speech waveform corresponding to the utterance, and information regarding a length of sound of the utterance;
understanding content of the utterance by using the text corresponding to the utterance;
determining content of a response corresponding to the utterance by using the content of the utterance;
extracting a state of the utterance by using the text corresponding to the utterance, the speech waveform corresponding to the utterance, and the information regarding the length of the sound of the utterance;
determining a state of the response according to the state of the utterance;
generating a response sentence by using the content of the response; and
synthesizing speech corresponding to the response sentence with the state of the response taken into account.

7. The dialogue apparatus according to claim 2, wherein
the state of the response includes an utterance tone of the response, and
the generating generates the response sentence in consideration of the utterance tone of the response included in the state of the response.

8. The dialogue apparatus according to claim 2, wherein
the determining the state of the response determines the state of the response further according to at least one of the text corresponding to the utterance, the content of the utterance, the content of the response, or information obtained until the determining the content of the response determines the content of the response.

9. The dialogue apparatus according to claim 3, wherein
the determining the state of the response determines the state of the response further according to at least one of the text corresponding to the utterance, the content of the utterance, the content of the response, or information obtained until the determining the content of the response determines the content of the response.

10. The dialogue method according to claim 5, wherein
the state of the utterance includes at least an utterance speed, and an emotion of a person who makes the utterance.

11. The dialogue method according to claim 5, wherein
the state of the response includes an utterance tone of the response, and
the generating generates the response sentence in consideration of the utterance tone of the response included in the state of the response.

12. The dialogue method according to claim 5, wherein
the determining the state of the response determines the state of the response further according to at least one of the text corresponding to the utterance, the content of the utterance, the content of the response, or information obtained until the determining the content of the response determines the content of the response.

13. The dialogue method according to claim 10, wherein
the state of the response includes an utterance tone of the response, and
the generating generates the response sentence in consideration of the utterance tone of the response included in the state of the response.

14. The dialogue method according to claim 10, wherein
the determining the state of the response determines the state of the response further according to at least one of the text corresponding to the utterance, the content of the utterance, the content of the response, or information obtained until the determining the content of the response determines the content of the response.

15. The dialogue method according to claim 11, wherein
the determining the state of the response determines the state of the response further according to at least one of the text corresponding to the utterance, the content of the utterance, the content of the response, or information obtained until the determining the content of the response determines the content of the response.

16. The computer-readable non-transitory recording medium according to claim 6, wherein
the state of the utterance includes at least an utterance speed, and an emotion of a person who makes the utterance.

17. The computer-readable non-transitory recording medium according to claim 6, wherein
the state of the response includes an utterance tone of the response, and
the generating generates the response sentence in consideration of the utterance tone of the response included in the state of the response.

18. The computer-readable non-transitory recording medium according to claim 6, wherein
the determining the state of the response determines the state of the response further according to at least one of the text corresponding to the utterance, the content of the utterance, the content of the response, or information obtained until the determining the content of the response determines the content of the response.

19. The computer-readable non-transitory recording medium according to claim 16, wherein
the state of the response includes an utterance tone of the response, and
the generating generates the response sentence in consideration of the utterance tone of the response included in the state of the response.

20. The computer-readable non-transitory recording medium according to claim 16,
the determining the state of the response determines the state of the response further according to at least one of the text corresponding to the utterance, the content of the utterance, the content of the response, or information obtained until the determining the content of the response determines the content of the response.
